(19) United States
(12) Patent Application Publication
(10) Pub. No.: US 2015/0287064 A1
(43) Pub. Date: Oct. 8, 2015

(54) SYSTEMS AND METHODS FOR DETERMINING TRAVEL PATHS BASED ON CARDHOLDER TRANSACTIONS

(71) Applicant: MasterCard International Incorporated, Purchase, NY (US)

(72) Inventors: David Weis, Boerne, TX (US); Brian Dobson, Wilton, CT (US)

(73) Assignee: MasterCard International Incorporated, Purchase, NY (US)

(21) Appl. No.: 14/244,156

(22) Filed: Apr. 3, 2014

(51) Int. Cl. G06Q 30/02

(52) U.S. Cl. CPC G06Q 30/0205

(57) ABSTRACT

A computer-implemented method for generating travel paths based on cardholder transactions is provided. The method uses a computing device having a processor communicatively coupled to a memory. The method includes receiving a plurality of payment transactions from a plurality of cardholders, calculating by the computing device a plurality of modeled paths based on the plurality of payment transactions where each modeled path of the plurality of modeled paths identifies a series of two or more locations where a payment transaction was initiated by a specific cardholder during a specific period of time, and displaying by the computing device a selected subset of the plurality of modeled paths.

### BACKGROUND OF THE DISCLOSURE

The field of the disclosure relates generally to calculating cardholder travel paths, and more particularly to generating and displaying a map of cardholder travel paths based on past cardholder transactions.

Consumers today are provided with an increasing number of different merchant categories for purchasing goods or services, as well as, an increasing number of merchants available in each category. A category is a group of merchants offering a similar product or service. For example, the entertainment area includes multiple categories such as entertainment experience, a dining category, an events category, a night club category, and an activities category. In many cities, consumers have hundreds if not thousands of restaurant options when they desire to eat. Moreover, even when the restaurant options are narrowed by restaurant category or cuisine, there may still be an inconveniently large number of restaurant options presented to the consumer. This is especially true when the consumer is traveling away from home.

### BRIEF DESCRIPTION OF THE DISCLOSURE

In one aspect, a computer-implemented method for generating travel paths based on cardholder transactions is described. The method is implemented using a computing device having a processor communicatively coupled to a memory. The method includes receiving a plurality of payment transactions from a plurality of cardholders, calculating by the computing device a plurality of modeled paths based on the plurality of payment transactions where each modeled path of the plurality of modeled paths identifies a series of two or more locations where a payment transaction was initiated by a specific cardholder during a specific period of time, and displaying by the computing device a selected subset of the plurality of modeled paths.

In another aspect, a computer system for generating travel paths based on cardholder transactions is described. The computer system includes a memory device for storing data and a processor in communication with the memory device. The processor is programmed to receive a plurality of payment transactions from a plurality of cardholders, calculate a plurality of modeled paths based on the plurality of payment transactions where each modeled path of the plurality of modeled paths identifies a series of two or more locations where a payment transaction was initiated by a specific cardholder during a specific period of time, and display a selected subset of the plurality of modeled paths.

A computer-readable storage medium having computer-executable instructions embodied thereon is described. When executed by a computing device having at least one processor coupled to a memory device, the computer-executable instructions cause the processor to receive a plurality of payment transactions from a plurality of cardholders, calculate a plurality of modeled paths based on the plurality of payment transactions where each modeled path of the plurality of modeled paths identifies a series of two or more locations where a payment transaction was initiated by a specific cardholder during a specific period of time and display a selected subset of the plurality of modeled paths.

### BRIEF DESCRIPTION OF THE DRAWINGS

FIGS. 1-8 show example embodiments of the methods and systems described herein.

FIG. 1 is a schematic diagram illustrating an example multi-party transaction card industry system for enabling ordinary payment-by-card transactions in which merchants and card issuers do not need to have a one-to-one special relationship.

FIG. 2 is a simplified block diagram of an example computer system including a plurality of computer devices in accordance with one example embodiment of the present disclosure.

FIG. 3 illustrates an example configuration of a client system shown in FIG. 2, in accordance with one embodiment of the present disclosure.

FIG. 4 illustrates an example configuration of the server system shown in FIG. 2, in accordance with one embodiment of the present disclosure.

FIG. 5 is a diagram of an example user interface on a client system displaying modeled paths, in accordance with one embodiment of the present disclosure.

FIG. 6 is a flowchart illustrating an example of the process of generating modeled paths from cardholder transactions using the system shown in FIG. 2, in accordance with one embodiment of the disclosure.

FIG. 7 is a flowchart illustrating an example of the process of generating a subset of modeled paths to display to a user using the system shown in FIG. 2, in accordance with one embodiment of the present disclosure.

FIG. 8 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for providing cardholders the most traveled paths or routes taken by other cardholders. More specifically, the disclosure describes a path generating (“PG”) computing device configured to collect transaction data for a plurality of payment cardholders transacting with a plurality of merchants, generate modeled paths based on the transactions of the plurality of payment cardholders, and display a selected subset of the modeled paths for a user.

In the example embodiment, the PG computing device is configured for use with a payment card processing network such as, for example, an interchange network. The PG computing device includes a memory device and a processor in communication with the memory device and is programmed to communicate with the payment network to receive transaction information for a plurality of cardholders. The payment network is configured to process payment card transactions between the merchant and its acquirer bank, and the cardholder and their issuer bank. Transaction information includes data relating to purchases made by cardholders at various merchants during a predetermined time period, including at least a merchant identifier, a geographic location of the merchant, and a cardholder identifier. In some embodiments, the plurality of purchases made by the cardholders are related to each other as being in the same market category, for example, but not limited to, a dining category, an events category, a night club category, or an activities category.

In the example embodiment, a payment card processing network receives a plurality of payment transactions for processing. The processing network stores these payment transactions in a database. The PG computing device is in communication with the payment network database. The PG computing device receives the transactions stored in the database. Each transaction includes at least a unique identifier for each cardholder, a geographic location of a merchant, and a date and time for the transaction.

The PG computing device selects all of the transactions that occurred within a specific time range (e.g., between 5:00 PM on Dec. 14, 2013, and 3:00 AM on Dec. 15, 2013) and within a specific geographic area (e.g., Manhattan, N.Y., south of 122^{nd} St.). From that subset of transactions, the PG computing device selects those cardholders with two or more transactions that met the above criteria. For example, the PG computing device may determine that on May 14^{th} a single cardholder had a transaction at 47^{th} Street and 6^{th} Avenue at 5:44 pm, another transaction at 48^{th} Street and 5^{th} Avenue at 6:05 pm, and a third transaction at 55^{th} Street and 5^{th} Avenue at 8:05 pm.

For each selected cardholder, the PG computing device retrieves the geographic location of each of the transactions and calculates a modeled path that the cardholder may have taken to travel between each of the transactions. For example, the PG computing device may calculate that the aforementioned cardholder traveled from the first transaction, at 47th Street and 6th Avenue, to the second transaction, at 48th Street and 5th Avenue, by traveling from 47th Street to 48th Street along 6th Avenue and then followed 48th Street to reach 5th Avenue. Then the PG computing device calculates that in travelling between the second and third transactions, the cardholder traveled along 5th Avenue from 48th Street to 55th Street. This modeled path is purely based on the transactions that the cardholder made. The PG computing devices stores the modeled path, which includes at least a unique identifier for the modeled path (this identifier is not connected to the unique identifier for the cardholder whose transactions the path was modeled from), a model time for a first transaction included within each modeled path (“first transaction model time”), a model time for a last transaction included within each modeled path (“last transaction model time”), and a model merchant category for each of the transactions on the modeled path.

In the example embodiment, the PG computing device receives a user request to display the paths from a user device (e.g., a smart phone). The user request includes at least a user starting location and a user starting time. The user starting location and user starting time can be inputted by the user or captured from the user device (e.g., geo-location data from a GPS device). The PG computing device selects the paths based on a distance between the user starting location and the modeled paths, and a time comparison between the user starting time and the first transaction model time. The PG computing device generates a travel map by combining the selected modeled paths with a map of the geographic area around the user starting location. The PG computing device transmits the travel map to the user device and instructs the user device to display the travel map to the user.

In a further embodiment, the PG computing device may also select modeled paths to display based on merchant category. For example, the user request may also include a user selected category, such as shopping or restaurants. In this example, the PG computing device generates a travel map that includes modeled paths where the model merchant category matches the user selected category.

In another embodiment, the PG computing device may also select modeled paths to display based on the region of residence of the cardholders whose transactions were used to generate the model paths. The PG computing device also stores, as a part of the modeled path, the region that the cardholder resides in (e.g., England) (“model region”). The user request may contain a user selected region. The PG computing device generates a travel map that includes modeled paths where the model region matches the user selected region. For example, a user from England travels to New York City. The English user may request to see the modeled paths in New York City of other travelers from England. The PG computing device generates the travel map to show the modeled paths of based on transactions of cardholders whose country of residence was England. While in this example the modeled region was a country, in other embodiments the modeled region may be for example, a state, a city, or a zip code.

The methods and systems described herein may be implemented using computer programming or engineering techniques including computer software, firmware, hardware, or any combination or subset wherein a technical effect of the systems and processes described herein is achieved by performing at least one of the following steps: (a) providing a path generating computing device in communication with a payment processing network and a memory, where the memory may be a part of the payment processing network or it may be separate; (b) receiving a plurality of payment transactions from a plurality of cardholders; (c) selecting a subset of payment transactions from the plurality of payment transactions based on a model time-frame and a model geographic area, wherein each payment transaction within the subset of payment transactions contains at least a time, a date, a merchant category, and a geographic location of a merchant; (d) selecting a subset of cardholders with two or more payment transactions within the subset of payment transactions; (e) calculating a modeled path for each of the subset of cardholders based on the two or more payment transactions within the subset of payment transactions; (f) storing the plurality of modeled paths; (g) determining a display start point based on at least one of a current location of a user or a user selected starting point; (h) determining a display time-frame based on at least one of a current time or a user selected time; (i) selecting at least one modeled path from the plurality of modeled paths based on the display starting point and the display time-frame and at least one of a model time-frame associated with the payment transactions associated with the modeled path, a model path region based on a home region associated with the individual cardholder upon whose transactions the modeled path was calculated, and a model merchant category based on a merchant category associated with the payment transactions associated with the modeled path; and (j) displaying the at least one selected modeled path.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

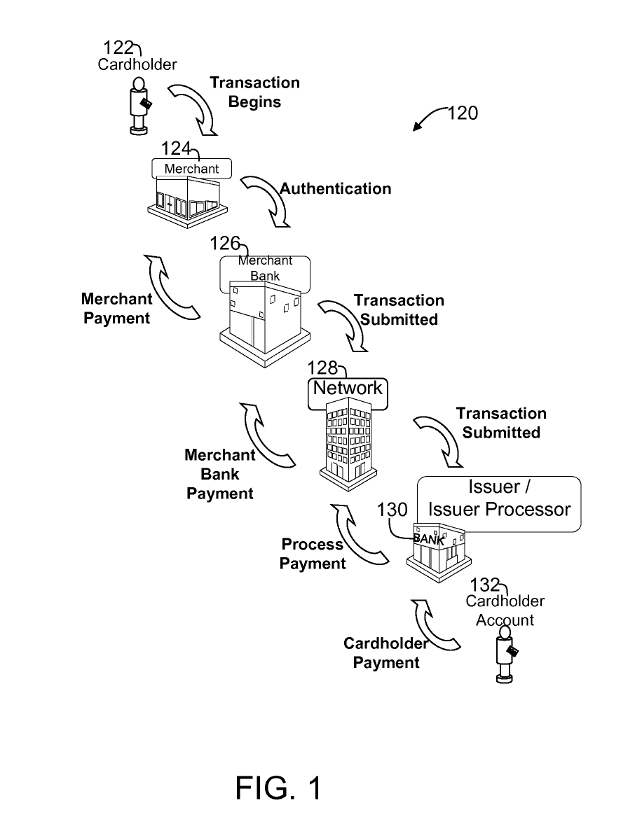

FIG. 1 is a schematic diagram illustrating an example multi-party transaction card industry system 120 for enabling ordinary payment-by-card transactions in which merchants 124 and card issuers 130 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

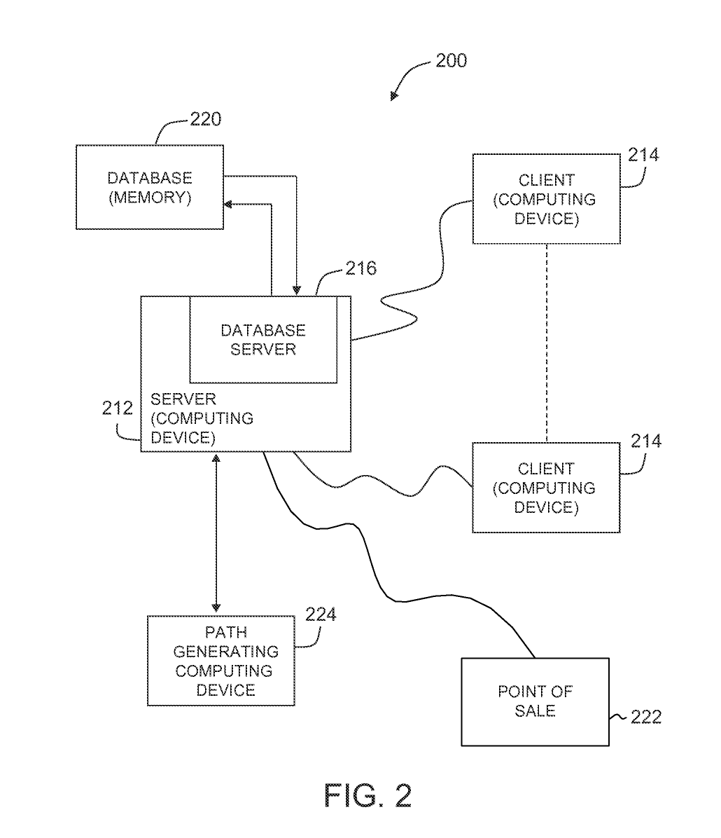

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 including a plurality of computer devices in accordance with one example embodiment of the present disclosure. In the example embodiment, system 200 may be used for performing payment-by-card transactions received as part of processing cardholder transactions. In addition, system 200 is a payment processing system that includes a path generating (“PG”) computing device 224 configured to generate modeled paths based on cardholder transactions. As described below in more detail, PG computing device 224 is configured to collect transaction information from a plurality of transactions from a plurality of cardholders, generate modeled paths based on the plurality of transactions, and display a selected subset of modeled paths to a user.

In the example embodiment, client systems 214 are computers that include a web browser or a software application, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, or other web-based connectable equipment.

A database server 216 is communicatively coupled to a database 220 that stores data. In one embodiment, database 220 includes transaction information from a plurality of cardholders and paths based on those transactions. In the example embodiment, database 220 is stored remotely from server system 212. In some embodiments, database 220 is decentralized. In the example embodiment, a person can access database 220 via client systems 214 by logging onto server system 212, as described herein.

The PG computing device 224 is communicatively coupled with the server system 212. The PG computing device 224 can access the server system 212 to store and access data and to communicate with the client systems 214 through the server system 212. In some embodiments, the PG computing device 224 may be associated with, or is part of the payment system, or in communication with the payment card system payment network 120, shown in FIG. 1. In other embodiments, the PG computing device 224 is associated with a third party and is merely in communication with the payment network 120.

One or more point of sale systems 222 are communicatively coupled with the server system 212. The one or more point of sale systems 222 can be merchants 124 shown in FIG. 1, where the point of sale systems 222 are communicatively coupled with the server system through the payment network 120. Point of sale systems 222 may be, but are not limited to, machines that accept card swipes, online payment portals, or stored payment card numbers for recurring transactions.

In some embodiments, server system 212 may be associated with a financial transaction interchange network 128 shown in FIG. 1, and may be referred to as an interchange computer system. Server system 212 may be used for processing transaction data and for registering cardholders and/or merchants into a plurality of programs offered by the interchange network, including, but not limited to, a rewards program. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 or point of sales devices 222 may include point-of-sale (POS) devices associated with a merchant and used for processing payment transactions. POS devices may be, but are not limited to, machines that accept card swipes, online payment portals, or stored payment card numbers for recurring transactions.

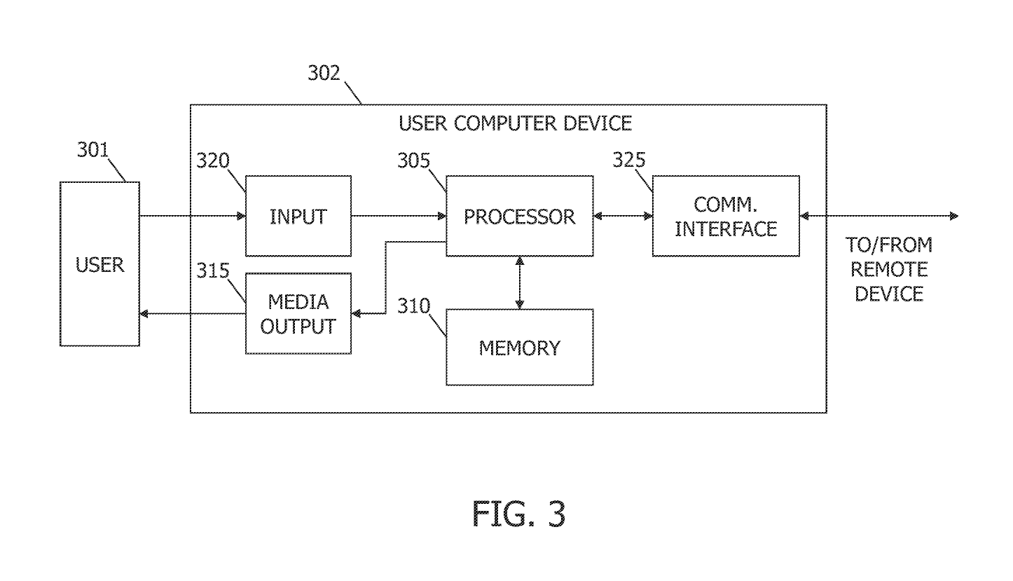

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214 (shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

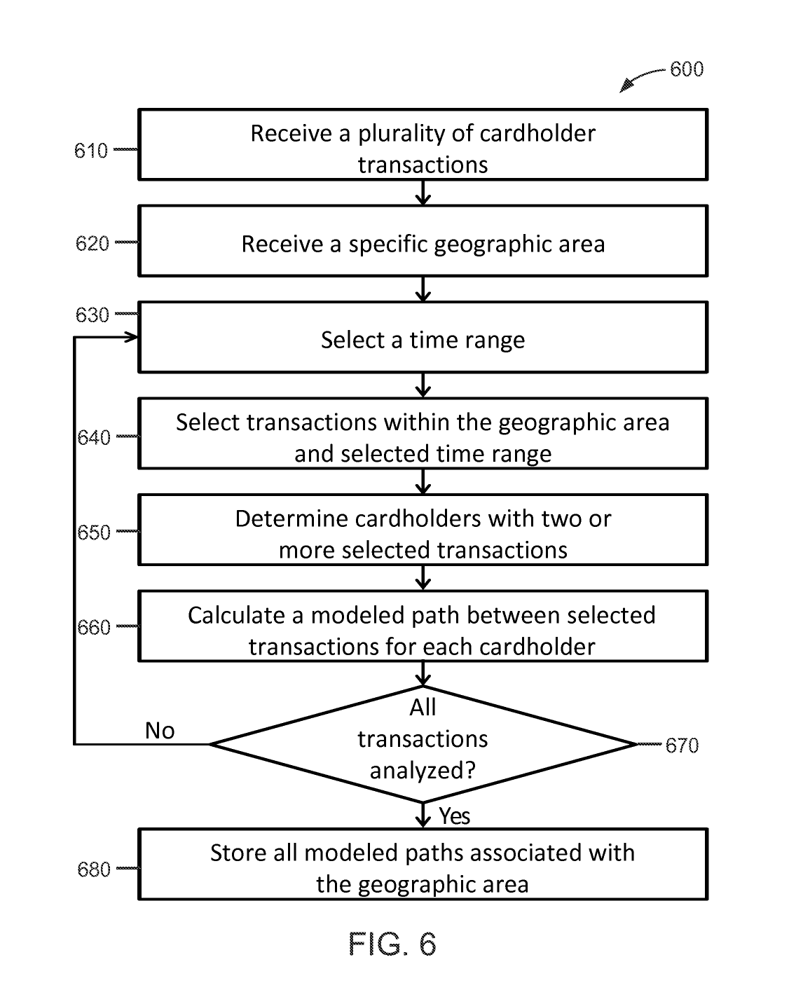

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 is programmed with the instruction such as illustrated in FIGS. 6 & 7.

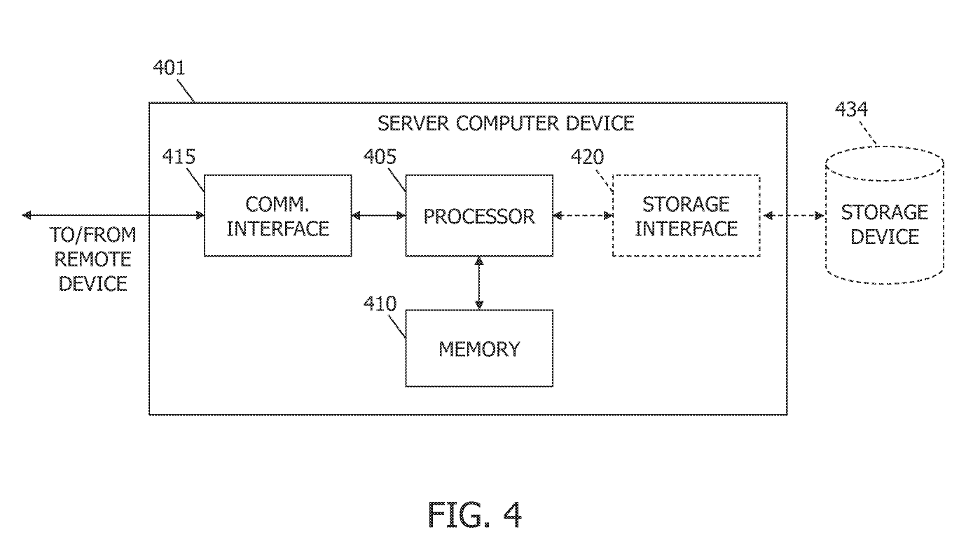

FIG. 4 illustrates an example configuration of the server system 212 shown in FIG. 2, in accordance with one embodiment of the present disclosure. Server computer device 401 may include, but is not limited to, database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, or PG computing device 224 (both shown in FIG. 2). For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

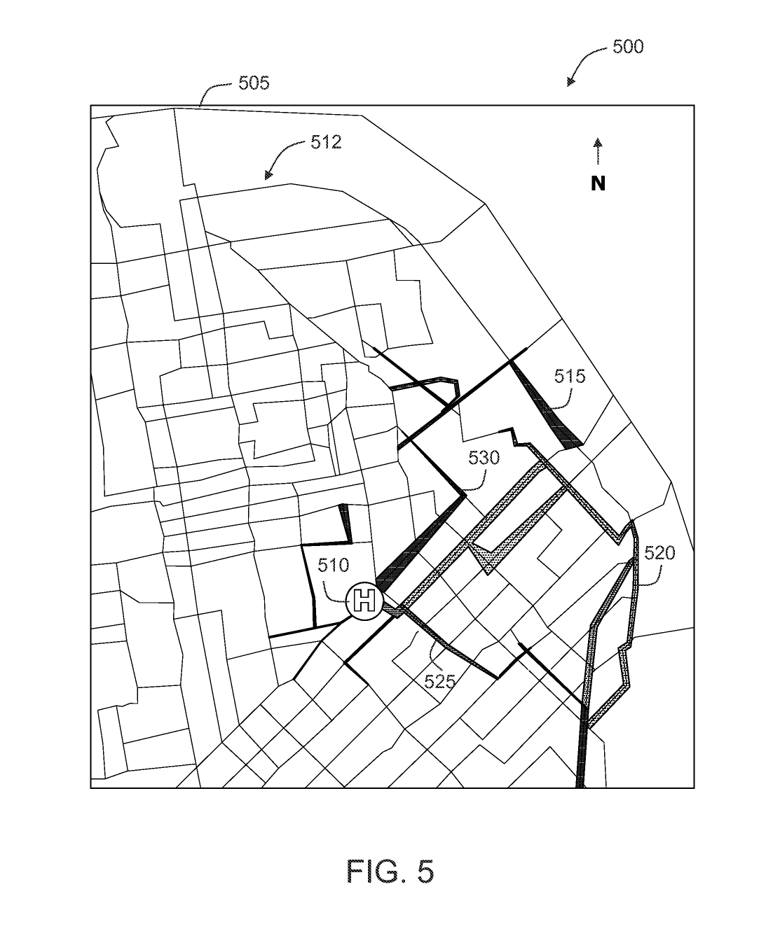

FIG. 5 is a diagram of an example user interface 500 displayed on client system 214 (shown in FIG. 2), such as a user or cardholder device, for displaying modeled paths from a user starting location 510, in accordance with one embodiment of the present disclosure. In the example embodiment, the user interface 500 displays a map 505 of a geographic area surrounding the user starting location 510 on client system 214 for user 301. The map 505 includes a plurality of city streets 512. While in this particular embodiment, the map 505 displays the individual city streets 512 surrounding the user starting location 510, in other embodiments the map 505 may include, for example, roads, highways, interstates, walking paths, bus routes, subway lines, bike paths, and/or sections of a shopping center/mall. In this embodiment, the user starting location 510 is a hotel. In other embodiments, the user starting location 510 may be any starting location desired, for example a user's current location sent from the user's mobile device, (e.g., geo-location data from a GPS device).

In addition to the user starting location 510, the user interface 500 displays a plurality of modeled paths 515, 520, 525, and 530. These modeled paths vary in thickness to show the relative number of cardholders who traveled each modeled path. In this embodiment, modeled path 530 is thicker than modeled path 525 to show that more cardholders completed transactions along modeled path 530 than modeled path 525. In the example embodiment, modeled path 515 widens going from northwest to southeast which represents that more transactions were made on the southeastern part of the street than the northwestern. Modeled path 520 is mostly uniform which represents that transactions were made consistently along that path.

In some embodiments, the user interface 500 may be configured to display different modeled paths as different colors to show different activities along those modeled paths. For example, modeled path 530 may be colored red to display paths taken by cardholders that completed transactions at restaurants, modeled path 520 may be colored green to display paths taken by cardholders that completed transactions at retail stores, and modeled path 525 may be colored orange to display paths taken by cardholders that completed transactions at bars and nightclubs.

FIG. 6 is a flowchart illustrating an example of the process 600 of generating the modeled paths from cardholder transactions using the system 200 shown in FIG. 2, in accordance with one embodiment of the disclosure. Process 600 may be implemented by a computing device, for example the PG computing device 224 (shown in FIG. 2). In the example embodiment, the PG computing device 224 receives 610 a plurality of cardholder transactions. The plurality of cardholder transactions may be received from the database server 216, where the cardholder transactions may have been stored in the database 220 (both shown in FIG. 2). In the example embodiment, the plurality of cardholder transactions may include cardholder transactions over a significant period of time, e.g., six months. Each transaction includes at least a unique identifier for each cardholder, a geographic location of a merchant, and a date and time for the transaction.

The PG computing device 224 receives 620 a specific geographic area. In one embodiment, the specific geographic area may be received from a client system 214. In another embodiment, the PG computing device 224 may receive the specific geographic area from the server system 212. In the example embodiment, the specific geographic area received by the PG computing device 224 is Manhattan, N.Y., south of 122^{nd} St. In other embodiments, the specific geographic area may be within a certain distance of a specific latitude and longitude or landmark, within an area bounded by streets, latitude and longitude coordinates, or any other method of a defining a geographic area.

The PG computing device 224 then selects 630 a time range to analyze. This time range may be for example 5:00 pm to 11:00 pm on May 3, 2013. The time range may be chosen to represent a specific time of interest, as in this example, a Friday evening. In other embodiments, the time range may be chosen to look for transactions that occurred within a specific amount of time of each other. For example, the PG computing device 224 may be looking for multiple transactions from the same cardholder that occurred within 3 hours of each other.

Then the PG computing device 224 selects 640 transactions that are within the specific geographic area and within the selected time range to create a subset of transactions by comparing the specific geographic area and the selected time range with the geographic location of the merchant and the date and time of the transaction. Within this subset of transactions, the PG computing device 224 determines 650 which cardholders have two or more transactions. For example, the PG computing device 224 may determine that on May 3^{rd} a single cardholder had a transaction at 47^{th} Street and 6^{th} Avenue at 5:44 pm, another transaction at 48^{th} Street and 5^{th} Avenue at 6:05 pm, and a third transaction at 55^{th} Street and 5^{th} Avenue at 8:05 pm.

For each cardholder with two or more transactions within the above subset of transactions, the PG computing device 224 calculates 660 a modeled path between the transactions for each cardholder. In the above example, the PG computing device 224 may calculate that the aforementioned cardholder traveled from the first transaction, at 47^{th} Street and 6^{th} Avenue, to the second transaction, at 48^{th} Street and 5^{th} Avenue, by traveling from 47^{th} Street to 48^{th} Street along 6^{th} Avenue and then followed 48^{th} Street to reach 5^{th} Avenue. Then the PG computing device 224 calculates that in travelling between the second and third transactions, the cardholder traveled along 5^{th} Avenue from 48^{th} Street to 55^{th} Street. This modeled path is purely based on the transactions that the cardholder made. The PG computing devices 224 stores the modeled path, which includes at least a unique identifier for the modeled path (this identifier is not connected to the unique identifier for the cardholder whose transactions the path was modeled from), a model time for a first transaction included within each modeled path (“first transaction model time”), a model time for a last transaction included within each modeled path (“last transaction model time”), and a model merchant category for each of the transactions on the modeled path.

Once the PG computing device 224 has calculated a modeled path for each of the cardholders with two or more transactions, then the PG computing device 224 checks 670 to see if it has analyzed all of the transactions. If not, then the PG computing device 224 goes back to step 630 to select a new time range. Once the PG computing device 224 has analyzed all of the potential time frames within the received plurality of cardholder transactions, the PG computing device 224 stores 680 the modeled paths associated with the specific geographic area. In the example embodiment, the PG computing device 224 stores the modeled paths in the database 220.

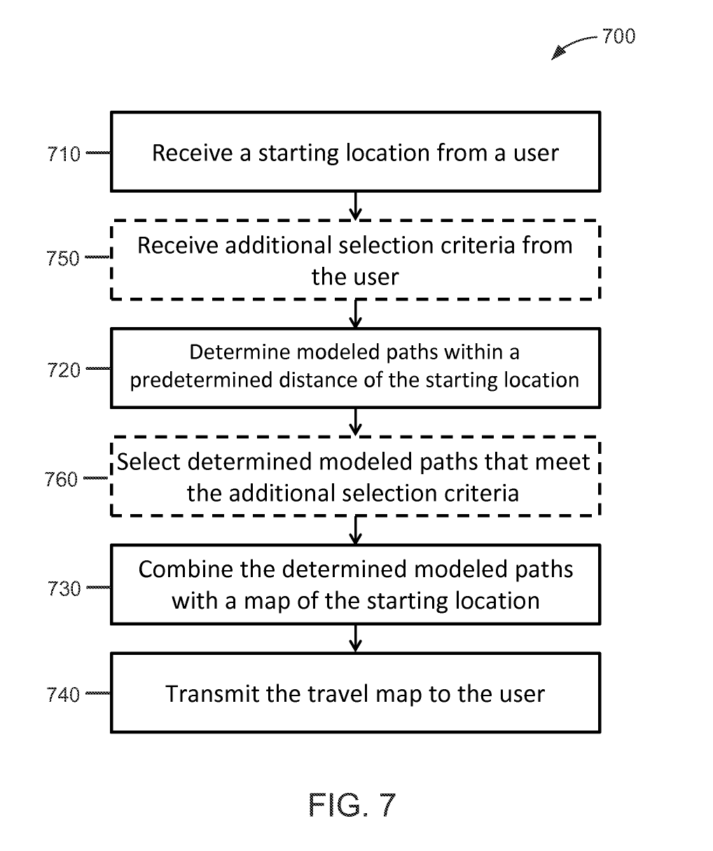

FIG. 7 is a flowchart illustrating an example process 700 of generating a travel map for a user using the system 200 shown in FIG. 2, in accordance with one embodiment of the present disclosure. Process 700 may be implemented using a computing device, for example the PG computing device 224 (shown in FIG. 2). In the example embodiment, the PG computing device 224 receives 710 the user starting location 510 from a user. The user may be user 301 from FIG. 3. The PG computing device 224 may receive the request from the user 301 through communication with client system 214 via server system 212. The user starting location 510 shown in FIG. 5 can be inputted by the user or captured from the user device (e.g., geo-location data from a GPS device).

Next, the PG computing device 224 determines 720 which modeled paths are within a predetermined distance of the user starting location 510. The PG computing devices 224 then combines 730 those determined modeled paths with a map 505 shown in FIG. 5, of the geographic area surrounding the user starting location 510 to create a travel map. In the example embodiment, for each modeled path the PG computing device 224 draws a line on the map 505 along the city streets 512, shown in FIG. 5, that the modeled path follows. To represent multiple modeled paths along the same city street 512, the PG computing device 224 increases the thickness of the line based on the number of modeled paths that follow that city street 512. In some embodiments, the PG computing device 224 may extend paths to the user starting location 510 as shown in FIG. 5.

Once the PG computing device 224 finishes combining the modeled paths and the map 505, the PG computing device 224 transmits 740 the travel map to the user's client system 214 (shown in FIG. 2) to be displayed to the user 301. In other embodiments, the PG computing device 224 may only transmit the modeled paths and the user's client system 214 may combine the modeled paths with a map.

Optionally, in some embodiments, the PG computing device 224 may receive 750 additional selection criteria from the user. This additional selection criterion may include a user start time, a time range, a day of the week, a merchant category, or a cardholder origin type. The PG computing device 224 selects 760 those determined modeled paths that meet the additional selection criteria to further narrow the modeled paths that are selected to be combined with the map 505. For example, user start time may be the current time of day that the PG computing device 224 received the user start time from the user 301 or it may be inputted by the user. In this case, the PG computing device 224 would only select modeled paths that contain transactions whose first transaction model time or last transaction model time is within a certain amount of time from the user start time. For example if the certain amount of time was two hours and the user start time was 3 pm, then the PG computing device 224 would select a modeled path whose first transaction model time was 4:30 pm. The PG computing device 224 may also use a time frame to select modeled paths that fit entirely within the time frame or modeled paths that start or finish within the time frame.

In one embodiment, the PG computing device 224 may also select modeled paths to display based on merchant category. For example, the user request may also include a user selected category, such as shopping or restaurants. In this example, the PG computing device 224 generates a travel map that includes modeled paths where the model merchant category matches the user selected category.

In another embodiment, the PG computing device 224 may also select modeled paths to display based on the originated region of the cardholders whose transactions were used to generate the model paths. The PG computing device 224 also stores, as a part of the modeled path, the region that the cardholder is from (e.g., England) (“model region”). The user request may contain a user selected region. The PG computing device 224 generates a travel map that includes modeled paths where the model region matches the user selected region.

In one embodiment, the PG computing device 224 may use the merchant category to select modeled paths that contain transactions at a certain merchant category, e.g., shopping or restaurants. The PG computing device 224 may use the cardholder origin type to only select modeled paths associated with cardholders from certain geographic regions. For example, the PG computing device 224 selects paths associated with cardholders whose country of residence is France.

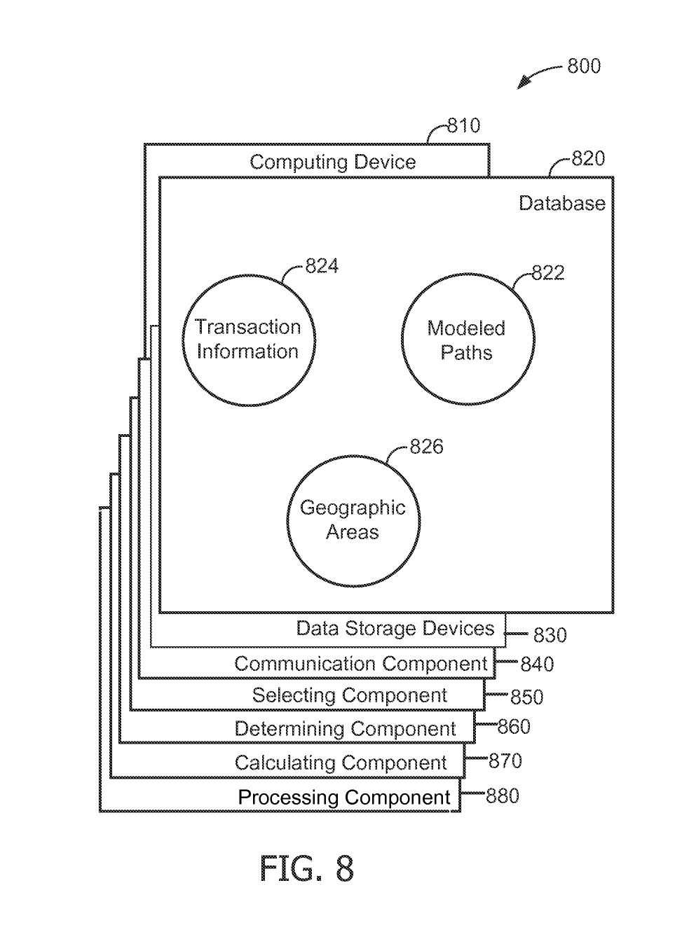

FIG. 8 is a diagram 800 of components of one or more example computing devices that may be used in the system 200 shown in FIG. 2. In some embodiments, computing device 810 is similar to server system 212; it may also be similar to PG computing device 224 (both shown in FIG. 2). Database 820 may be coupled with several separate components within computing device 810, which perform specific tasks. In this embodiment, database 820 includes modeled paths 822, transaction information 824, and geographic areas 826. In some embodiments, database 820 is similar to database 220 (shown in FIG. 2).

Computing device 810 includes the database 820, as well as data storage devices 830. Computing device 810 also includes a communication component 840 for receiving a user starting location 510 from client systems 214 (shown in FIG. 2), for receiving transaction information 824, and for sending travel maps or modeled paths to client systems 214. Computing device 810 also includes a selecting component 850 for selecting time ranges, selecting transactions that meet selection criteria, and selecting modeled paths 822 that meet selection criteria. A determining component 860 is also included for determining cardholders with two or more transactions and modeled paths 822 within a predetermined distance of the user starting location 510 (shown in FIG. 5). A calculating component 870 is also included for calculating the modeled path 822 based on the transaction information 824. A processing component 880 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for generating travel paths based on cardholder transactions, said method using a computing device having a processor communicatively coupled to a memory, said method comprising:
receiving a plurality of payment transactions from a plurality of cardholders;
calculating, by the computing device, a plurality of modeled paths based on the plurality of payment transactions, wherein each modeled path of the plurality of modeled paths identifies a series of two or more locations where a payment transaction was initiated by a specific cardholder during a specific period of time; and
displaying, by the computing device, a selected subset of the plurality of modeled paths.

2. The method in accordance with claim 1, wherein calculating the plurality of modeled path further comprises:
selecting a subset of payment transactions from the plurality of payment transactions based on a model time-frame and a model geographic area, wherein each payment transaction within the subset of payment transactions includes at least a time, a date, a merchant category, and a geographic location of a merchant;
selecting a subset of cardholders having two or more associated payment transactions included within the subset of payment transactions;
calculating a modeled path for each of the subset of cardholders based on the associated payment transactions included within the subset of payment transactions; and
storing the plurality of modeled paths.

3. The method in accordance with claim 1, wherein displaying a selected subset of the plurality of modeled paths further comprises:
determining a display start point based on at least one of a current location of a user or a user selected starting point;
determining a display time-frame based on at least one of a current time or a user selected time;
selecting at least one modeled path from the plurality of modeled paths based on the display starting point and the display time-frame; and
displaying the at least one selected modeled path.

4. The method in accordance with claim 1, further comprising determining a display starting point, wherein displaying the plurality of modeled paths is further based on a proximity to the display starting point.

5. The method in accordance with claim 1, wherein displaying a selected subset of the plurality of modeled paths further comprises selecting a subset of modeled paths to display from the plurality of modeled paths based on a user input.

6. The method in accordance with claim 1, wherein displaying a selected subset of the plurality of modeled paths further comprises:
determining one or more segments where a plurality of modeled paths overlap and
displaying each of the one or more segments as a line where the thickness of the line is based on the number of modeled paths that overlap at that segment.

7. The method in accordance with claim 1, wherein displaying a selected subset of the plurality of modeled paths further comprises selecting a subset of modeled paths to display based on at least one of a model time-frame associated with the payment transactions associated with the modeled path, a model path region based on a home region associated with the individual cardholder upon whose transactions the modeled path was calculated, and a model merchant category based on a merchant category associated with the payment transactions associated with the modeled path.

8. The method in accordance with claim 1, wherein calculating a plurality of modeled paths is further based on the two or more transactions that occur within a predetermined distance of each other.

9. The method in accordance with claim 1, wherein calculating a plurality of modeled paths is further based on the two or more transactions that occur within a predetermined length of time.

10. The method in accordance with claim 1, where displaying a selected subset of the plurality of modeled paths further comprises:
determining at least one model merchant category for each of the plurality of modeled paths based on a merchant category associated with the payment transactions associated with the modeled path;
selecting a subset of modeled paths based on the associated model merchant category; and
displaying the subset of modeled paths as a series of colored lines where the color of the line is based on the model merchant category.

11. A computer system for generating travel paths based on cardholder transactions, said computer system comprising:
a memory device for storing data; and
a processor in communication with said memory device, said processor programmed to:
receive a plurality of payment transactions from a plurality of cardholders;
calculate a plurality of modeled paths based on the plurality of payment transactions, wherein each modeled path of the plurality of modeled paths identifies a series of two or more locations where a payment transaction was initiated by a specific cardholder during a specific period of time; and
display a selected subset of the plurality of modeled paths.

12. The system in accordance with claim 11, wherein said processor is further programmed to:
select a subset of payment transactions from the plurality of payment transactions based on a model time-frame and a model geographic area, wherein each payment transaction within the subset of payment transactions contains at least a time, a date, a merchant category, and a geographic location of a merchant;
select a subset of cardholders with two or more payment transactions within the subset of payment transactions;
calculate a modeled path for each of the subset of cardholders based on the two or more payment transactions within the subset of payment transactions; and
store the plurality of modeled paths.

13. The system in accordance with claim 11, wherein said processor is further programmed to:
determine a display start point based on at least one of a current location of a user or a user selected starting point;
determine a display time-frame based on at least one of a current time or a user selected time;
select at least one modeled path from the plurality of modeled paths based on the display starting point and the display time-frame; and
display the at least one selected modeled path.

14. The system in accordance with claim 11, wherein said processor is further programmed to:
determine a display starting point; and
display the plurality of modeled paths further based on a proximity to the display starting point.

15. The system in accordance with claim 11, wherein said processor is further programmed to select a subset of modeled paths to display from the plurality of modeled paths based on a user input.

16. The system in accordance with claim 11, wherein said processor is further programmed to select a subset of modeled paths to display based on at least one of a model time-frame associated with the payment transactions associated with the modeled path, a model path region based on a home region associated with the individual cardholder upon whose transactions the modeled path was calculated, and a model merchant category based on a merchant category associated with the payment transactions associated with the modeled path.

17. A computer-readable storage medium having computer-executable instructions embodied thereon, wherein when executed by a computing device having at least one processor coupled to a memory device, the computer-executable instructions cause the processor to:
receive a plurality of payment transactions from a plurality of cardholders;
calculate a plurality of modeled paths based on the plurality of payment transactions, wherein each modeled path of the plurality of modeled paths identifies a series of two or more locations where a payment transaction was initiated by a specific cardholder during a specific period of time; and
display a selected subset of the plurality of modeled paths.

18. The computer-readable storage medium of claim 17, wherein the computer-executable instructions further cause the processor:
select a subset of payment transactions from the plurality of payment transactions based on a model time-frame and a model geographic area, wherein each payment transaction within the subset of payment transactions contains at least a time, a date, a merchant category, and a geographic location of a merchant;
select a subset of cardholders with two or more payment transactions within the subset of payment transactions;
calculate a modeled path for each of the subset of cardholders based on the two or more payment transactions within the subset of payment transactions; and
store the plurality of modeled paths.

19. The computer-readable storage medium of claim 17, wherein the computer-executable instructions further cause the processor:
determine a display start point based on at least one of a current location of a user or a user selected starting point;
determine a display time-frame based on at least one of a current time or a user selected time;
select at least one modeled path from the plurality of modeled paths based on the display starting point and the display time-frame; and
display the at least one selected modeled path.

20. The computer-readable storage medium of claim 17, wherein the computer-executable instructions further cause the processor:
determine a display starting point; and
display the plurality of modeled paths further based on a proximity to the display starting point.
